(19) United States
(12) Patent Application Publication
(10) Pub. No.: US 2012/0293297 A1
(43) Pub. Date: Nov. 22, 2012

(54) MULTI-CONTACT TOUCH SENSOR WITH A HIGH ELECTRICAL CONTACT RESISTANCE

(75) Inventors: Pascal Joguet, Sadirac (FR); Guillaume Largillier, Bordeaux (FR); Julien Olivier, Bordeaux (FR)

(73) Assignee: Stantum, Bordeaux (FR)

(21) Appl. No.: 13/519,428

(22) PCT Filed: Jan. 4, 2011
(86) PCT No.: PCT/FR11/50009

§ 371 Date: Jun. 27, 2012

(30) Foreign Application Priority Data
Jan. 5, 2010 (FR) 1000034

(51) Int. Cl. H01C 10/10

(52) U.S. Cl. 338/47

(57) ABSTRACT

A multi-contact, tactile sensor including an upper layer including strip conductors arranged in lines, a lower layer including strip conductors arranged in columns, and a spacer positioned between the upper layer and the lower layer to insulate the upper layer and lower layer. An electromechanical mechanism is arranged between the upper and lower layers to increase electrical contact resistance during contact between at least one strip conductor of the upper layer and at least one strip conductor of the lower layer.

The present invention relates a multi-contact touch sensor.

It relates more particularly to a multi-contact touch sensor comprising:
an upper layer provided with conductive tracks organized in rows,
a lower layer provided with conductive tracks organized in columns,
spacing means positioned between the upper layer and the lower layer so as to insulate those upper and lower layers.

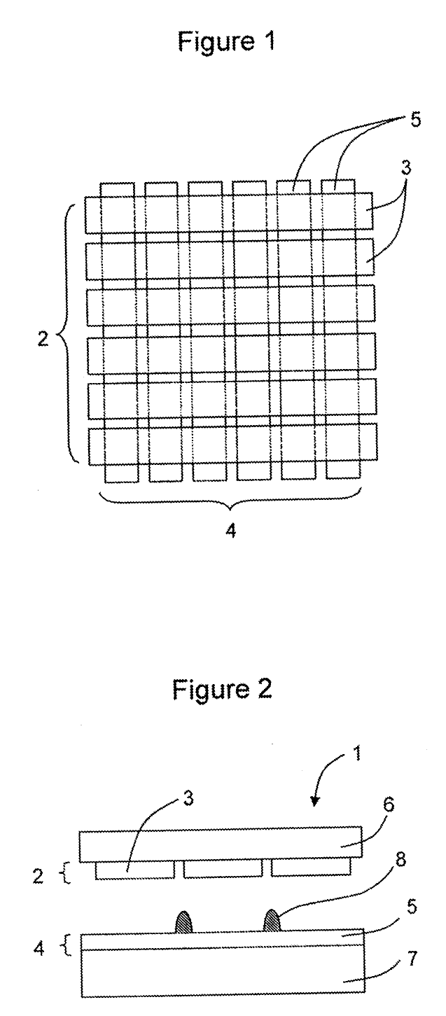

Such a sensor is described for example in the patent document EP 1 719 047. As illustrated by FIGS. 1 and 2, that sensor 1 operates so as to perform sequential scanning of the rows 3 and columns 5 of conductive tracks, which enables simultaneous detection of several zones of contact during the same scanning phase.

More particularly, when a user presses on the sensor, the upper layer 2 comes into contact with the lower layer 4 in the parts situated between the spacers 8. Both layers are provided with conductive tracks 3 and 5, and an electrical signal is introduced sequentially into the conductive tracks 3 of the upper layer 2, the detection taking place at the location of the conductive tracks 5 of the lower layer 4. The detection of a signal on some of those tracks thus enables the position of the points of contact to be located.

The upper and lower layers are for example formed from a translucent conductive material, for example transparent metal oxides such as ITO (indium tin oxide), solutions based on metal nanoparticles or conductive micro-wires. The upper layer may be positioned under a layer 6 of polyethylene terephthalate (PET) and the lower layer on a layer of glass 7.

When the user presses on the sensor, the conductive rows 3 enter into contact with the conductive columns 5 between the spacers 8.

While the transparent conductive materials have a non-negligible linear resistance along the rows and the columns, they however have a much lower vertical resistance at the locations of the zones of contact between the two layers.

In what follows, the conductive tracks which are powered will be called rows and those on which an electrical characteristic is measured will be called columns.

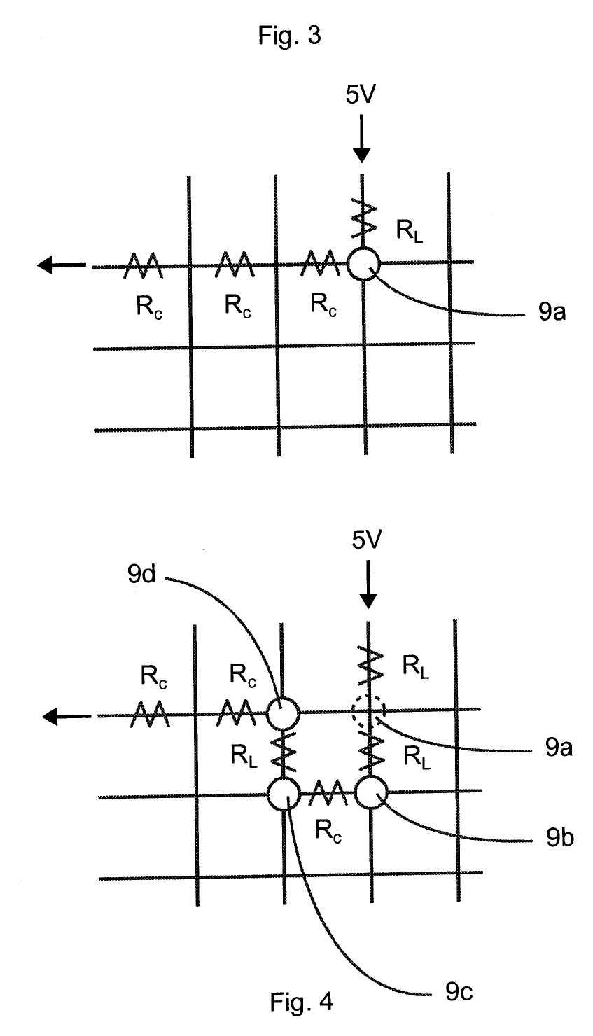

As illustrated by FIGS. 3 and 4, each column has a column resistance and each row has a row resistance. More particularly, each column portion has a column resistance R_{C} and each row portion has a row resistance R_{L}. Furthermore, when a row approaches a column, a contact resistance R_{T} arises between that row and that column.

When power is supplied to a row and the impedance on a column is measured to know whether there is a contact or not, the resistance induced by the resistive path along the rows and columns is measured.

In FIG. 3, there is a contact at the location of point 9a. Supplying power for the corresponding row enables a resistive path to be measured on the corresponding column equal to R_{L}+3 R_{C}+R_{T}, corresponding to the shortest resistive path between the end of the row which supplies power and the end of the column which measures.

In FIG. 4, there is no longer any contact at point 9a, but there are three contacts simultaneously at points 9b, 9c and 9d which are close to 9a. When power is supplied to the row corresponding to 9a and measurement is made on the corresponding column 9a, it is no longer the shortest resistive path which is measured (as in FIG. 3), but a resistive path is nevertheless measured between the row and the column of the point 9a, via points of contact 9b, 9c and 9d. A resistive path is thus measured which is equal to 3 R_{L}+3 R_{c}+3R-_{T}.

Thus, on account of the low contact resistance R_{T} (i.e. the vertical resistance) produced by the ITO, it is possible to measure resistive paths at points without contact, whose values may be substantially equal to those that would be given by that same point if it was a contact point. This may therefore lead to detection of a contact where there is no contact.

In particular, when several contact points are activated, and in particular orthogonally on the rows and the columns, the electrical characteristics appearing at the intersection of a row and a column are disturbed by the other contact points situated on those same rows and columns.

This phenomenon leads to problems of masking and orthogonality arising, which make the exact detection of contact zones difficult, since orthogonal relationships tend to limit detection to rectangular zones, even in the case of contact zones having more complex forms.

In the state of the art, these problems may be solved by virtue of electronic processing and various correction algorithms.

An object of the invention is to reduce the problems of masking and orthogonality at the contact points on the sensor without necessarily utilizing additional electronic processing.

This problem is solved according to the invention by a multi-contact touch sensor as described earlier, comprising electro-mechanical means arranged between the upper and lower layers adapted to reduce the contact area when a contact takes place between at least one conductive track of that upper layer and at least one conductive track of that lower layer.

Thanks to these additional electro-mechanical means, when a user presses on the sensor, an additional contact resistance between the upper layer and the lower layer is added.

Consequently, when the impedance is measured on a column after supplying power to a row, different results are obtained between a zone in which there is a contact and a zone were there is no contact. To be precise, where there is a contact, the portions of row and column resistance as well as the highest contact resistance are measured. Where there is no contact, portions of row and column resistance are measured, to which are added several contact resistances or none at all. Consequently, at a contact zone, an impedance is measured of an order of magnitude different from the impedance measured at a zone with no contact

This significant increase in the electrical contact resistance makes it possible to reduce the problems of masking and orthogonality, which originally had as their origin the low vertical resistance of the conductive tracks at the location of the zones of contact between the upper and lower layers. The simultaneous detection of a plurality of contact points is then possible, without recourse to additional electronic processing means.

Arbitrarily, it will be considered that the spacing means are disposed on the lower layer. The person skilled in the art will however note that those spacing means may be disposed on the upper layer, and in that case the disposition of the electro-mechanical means relative to the upper and lower layers should be reversed, in relation to what follows.

Similarly, it is possible to inverse the lower and upper layers, such that the tracks to which power is supplied are disposed in columns and those on which an electrical characteristic is measured are disposed in rows. A preponderant criterion is still that the conductive tracks respectively of the upper layer and of the lower layer be arranged so as to be orthogonal to each other.

According to a first variant embodiment, the electro-mechanical means comprise intermediate dielectric layers disposed between the lower layer and the spacing means.

In this latter case, the intermediate dielectric layers preferably take the form of a dielectric layer perforated at least at one point of potential contact between a conductive track of the upper layer and a conductive track of the lower layer. These perforations have a smaller area in the plane of the intermediate layer than that of the zone of potential contact between the rows and the columns. The contact area between the rows and the columns is thereby reduced, and the electrical contact resistance increased.

In the latter case, the dielectric layer is advantageously perforated at all the potential contacts between a conductive track of the upper layer and a conductive track of the lower layer.

Still in this latter case, the dielectric layer advantageously comprises several perforations at a single point of potential contact between a conductive track of the upper layer and a conductive track of the lower layer. These multiple perforations at the same potential contact (in a 2×2 or 3×3 matrix) enable the perforated surface to be modulated. On manufacture, tolerance is thereby improved and the formation of those perforations is thus better controlled.

According to a second variant embodiment, the electro-mechanical means comprise conductive studs disposed on one of the upper and lower layers, at a point of potential contact between a conductive track of the upper layer and a conductive track of the lower layer. The electrical contact thus takes place at those conductive studs. On account of their small surface area, the electrical contact between the rows and columns takes place over a smaller surface, which enables the electrical contact resistance to be increased. The electrical resistance of the conductive studs may be adjusted either by the geometric shape of the studs, or by the composition of the material constituting the studs which may have a higher or lower conductivity.

In the latter case, the conductive studs are advantageously disposed at the location of all the potential contacts between a conductive track of the upper layer and a conductive track of the lower layer.

According to a third variant embodiment, the electro-mechanical means comprise at least a proportion of the spacing means arranged to limit the electrical contact area when there is a contact between at least one conductive track of the upper layer and at least one conductive track of the lower layer. This variant has the advantage of not requiring additional means, by directly exploiting the spacing means, for an equivalent obtained result.

In this case, the arrangement of the spacing means advantageously consists in making them take up a large area, except at the location of the points of potential contact between a conductive track of the upper layer and a conductive track of the lower layer.

In order to reduce the area of electrical contact all the more, the above three variant embodiments may advantageously be combined.

Preferably, the upper and lower layers are transparent, such that the sensor is itself transparent.

Preferably, the conductive tracks of the upper layer and the conductive tracks of the lower layer form a matrix of cells.

The conductive tracks of the upper layer are advantageously constituted by transparent conductive oxide (for example of indium tin oxide ITO). Similarly, those of the lower layer are also advantageously constituted by transparent conductive oxide (for example of indium tin oxide ITO).

Lastly, the upper layer is preferably situated below a flexible layer (for example of polyethylene terephthalate PET) and the lower layer is situated above a rigid layer (for example of glass).

Other advantageous features of the invention are described below with reference to the appended drawings in which:

FIG. 1 represents a view from above of the arrangement of the rows and columns of conductive tracks of a multi-contact touch sensor of the prior art;

FIG. 2 represents a cross-section view of a multi-contact touch sensor of the prior art;

FIGS. 3 and 4 represent a diagram illustrating the different possible resistive paths in the prior art when supplying power to a row and measuring on a column.

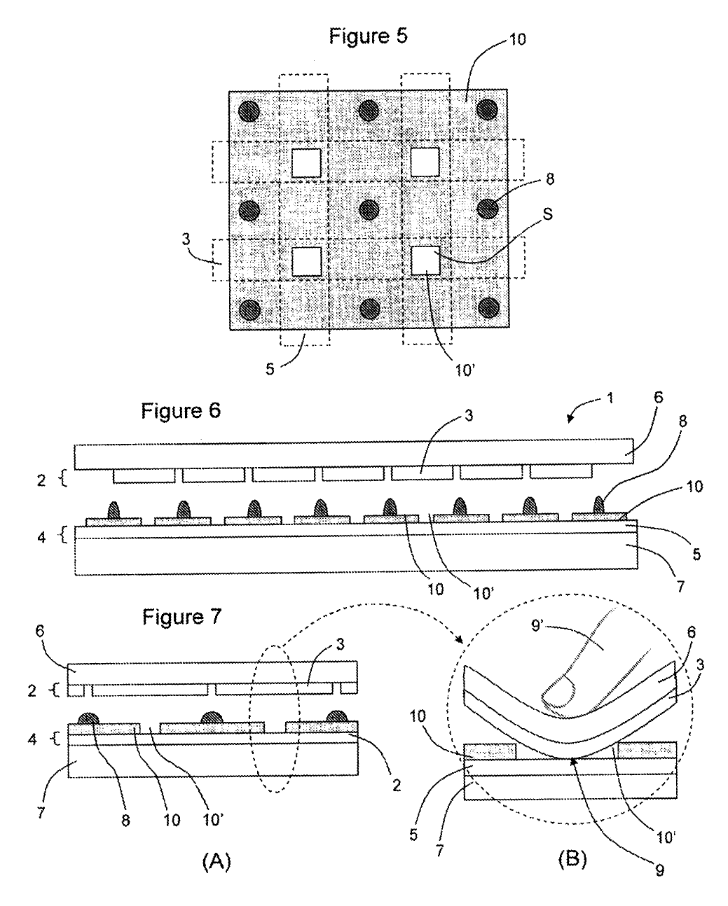

FIG. 5 represents a view from above of the arrangement of the electro-mechanical means according to a first embodiment;

FIG. 6 represents a cross-section view of a multi-contact touch sensor according to that first embodiment;

FIGS. 7A and 7B represent enlarged cross-section views of that sensor according to that first embodiment;

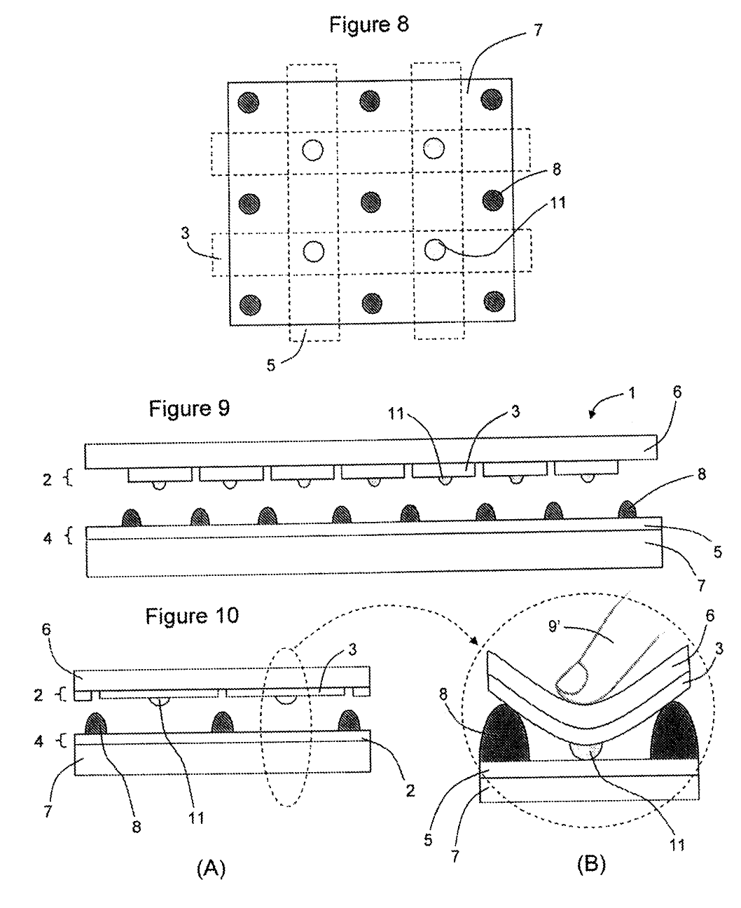

FIG. 8 represents a view from above of the arrangement of the electro-mechanical means according to a second embodiment;

FIG. 9 represents a cross-section view of a multi-contact touch sensor according to that second embodiment;

FIGS. 10A and 10B represent enlarged cross-section views of that sensor according to that second embodiment;

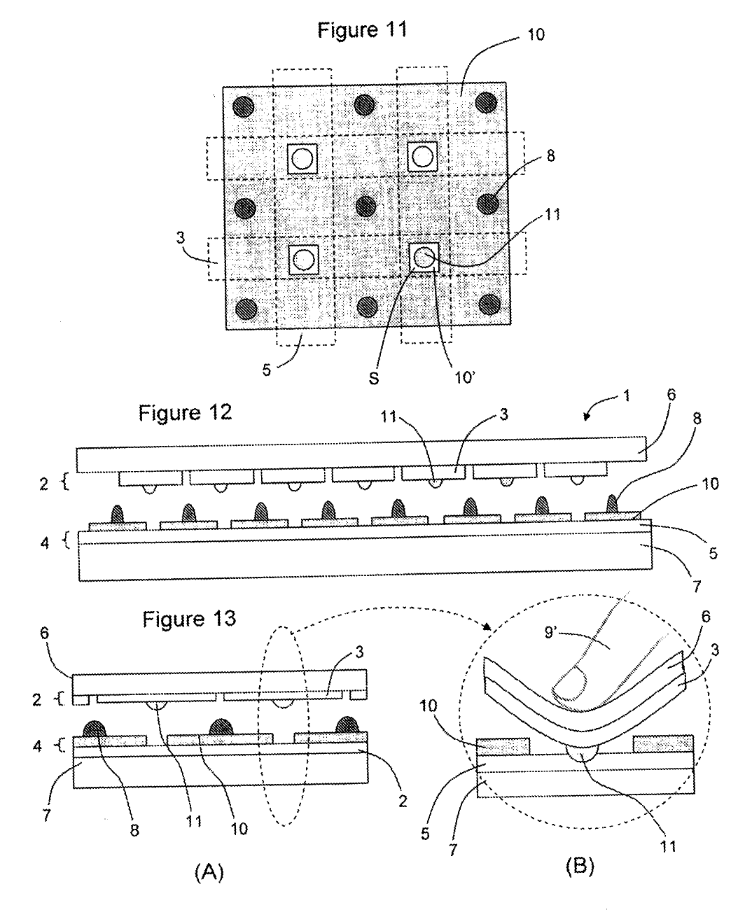

FIG. 11 represents a view from above of the arrangement of the electro-mechanical means according to a third embodiment;

FIG. 12 represents a cross-section view of a multi-contact touch sensor according to that third embodiment;

FIGS. 13A and 13B represent enlarged cross-section views of that sensor according to that third embodiment;

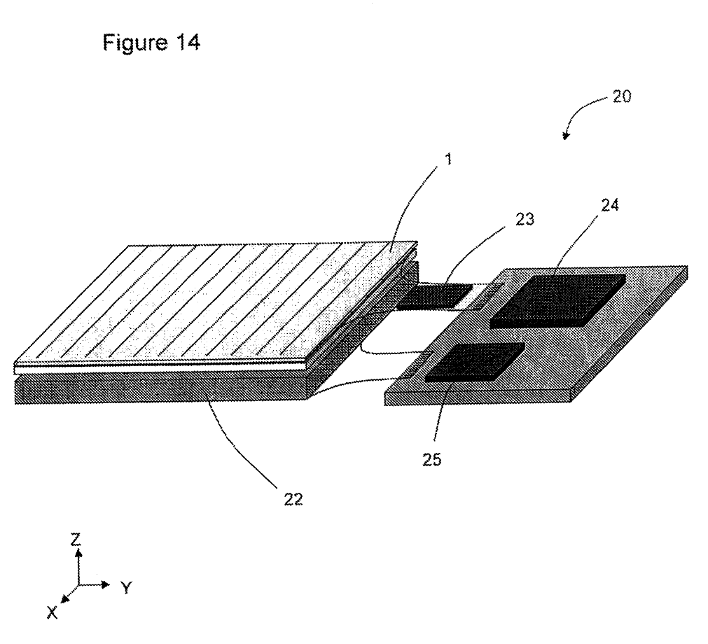

FIG. 14 represents a display device provided with a two-dimensional multi-contact touch sensor according to the invention;

For greater clarity in those Figures, identical references relate to similar technical elements.

For each of the embodiments described below, the spacing means are disposed on the lower layer. This arrangement is however arbitrary and the person skilled in the art will know how to adapt the invention to an arrangement other than that described below.

A multi-contact touch sensor according to a first embodiment of the invention has been represented in FIGS. 5, 6, 7A and 7B.

The multi-contact touch sensor 1 described here is preferably transparent, but it is to be understood that the invention is also applicable to a non-transparent sensor 1 thus comprising at least one non-transparent layer.

In FIGS. 5 and 6, the sensor 1 comprises an upper layer 2 provided with conductive tracks 3 organized in rows, as well as a lower layer 4 provided with conductive tracks 5 organized in columns. The arrangement of these tracks in rows and columns gives a matrix of cells, each cell being formed by the intersection of a conductive track 3 of the upper layer 2 and of a conductive track 5 of the lower layer 4. These conductive tracks are constituted by ITO (indium tin oxide), which is a translucent conductive material.

When it is wished to know whether a row has been placed in contact with a column, determining a contact point on the sensor 1, the electrical characteristics—voltage, current or resistance—are measured at the terminals of each row/column intersection of the matrix.

The sensor 1 also comprises, in its upper part, a layer 6 of PET (polyethylene terephthalate). The upper layer 2 is located under this layer 6 of PET. The upper layer 2 of ITO thus provides structuring for the layer 6 of PET and corresponds to the rows 3 of the sensor 1.

The sensor 1 further comprises a layer of glass 7 in its lower part. Above this layer is the lower layer 4. The lower layer 4 of ITO thus provides structuring for the glass layer 7 and corresponds to the columns 5 of the sensor 1.

It is understood that the concepts of rows and columns are relative and arbitrary concepts, and that they may therefore be interchanged according to the orientation of the sensor. Uniquely by convention, it will be considered that the upper layer 2 of ITO forms the rows of a matrix sensor, but it is clear for the person skilled in the art that it could also form the columns thereof. In that case, the lower layer 4 of ITO would form the rows of that matrix sensor. In both cases, the direction of the tracks 3 of ITO forming the upper layer 2 is perpendicular to the direction of the tracks 5 of ITO forming the lower layer 4.

As illustrated by FIGS. 6, 7A and 7B, spacers 8 are disposed between the upper layer 2 and lower layer 4 so as to insulate those layers from each other. More particularly, the spacers 8 are disposed so as to be linked to the lower layer 4. They are positioned at the location of the zones in which the tracks of the upper layer 2 and those of the lower layer 4 are not able to form intersections defining detection cells.

The person skilled in the art will understand that it is however possible to link the spacers 8 to the upper layer 2, or some spacers to the lower layer 4 and others to the upper layer 2, without however departing from the scope of the present invention.

According to this first embodiment, an intermediate layer 10 is disposed between the lower layer 4 and the spacers 8. This intermediate layer 10 is constituted by a material of high resistance and is preferably a dielectric layer. It is perforated in zones 10′ included within the zones of intersection between the conductive tracks 3 and 5. As well illustrated in FIG. 5, the area S of those perforations 10′ in the plane of the intermediate layer 10 is less than that of the zone of potential contact between the tracks 3 and 5, at the location of the intersections defining the detection cells.

In this manner, as illustrated in FIGS. 7A and 7B when a user 9′ presses on the sensor 1 the contact 9 between the conductive tracks 3 and 5 can only be made at the location of the area S defined by the perforations 10′ of the intermediate layer 10. The area of electrical contact between the tracks is thus reduced relative to a case with no intermediate layer 10, and the electrical contact resistance is thereby increased.

FIGS. 8, 9, 10A and 10B represent a second embodiment of the invention, in which the perforated intermediate layer 10 is replaced by conductive studs 11.

The sensor 1 still comprises an upper layer 2 provided with conductive tracks 3, a lower layer 4 provided with columns of conductive tracks 5 and spacers 8 disposed in zones in which those tracks 3 and 5 are not able to form an intersection when there is a contact.

In this embodiment, conductive tracks 11 are disposed on the conductive tracks 3 of the upper layer 2, at the location of zones capable of forming intersections with the conductive tracks 5 of the lower layer 4 when a contact is made by pressing on the sensor.

These studs may take an identical form to those of the spacers 8. These studs 11 are however conductive, since their role is to enable the passage of an electric current between the tracks 3 and 5 when the sensor 1 is pressed by a user 9′. They moreover have dimensions in the plane of the upper layer 2 that are smaller than the width of a conductive track 3.

Thanks to these studs 11, when a user 9′ presses on the sensor 1, the contact between the conductive tracks 3 and 5 is established at the location of the area defined by the conductive studs 11, and no longer at the location of the area defined by the intersection of the conductive tracks. The area of electrical contact between the tracks is thus reduced relative to a case without those conductive studs, and the electrical contact resistance is thereby increased.

FIGS. 11, 12, 13A and 13B lastly represent a third embodiment of the invention, in which the two embodiments described above have been combined together.

More particularly:
between the lower layer 4 and the spacers 8 is disposed an intermediate layer 10 having perforations 10′ situated at the zones of potential contact between the conductive tracks 3 and 5, those perforations 10′ having dimensions in the plane of the lower layer 4 that are less than the width of a track 5, and
on the conductive tracks 3 of the upper layer 2, are disposed conductive studs 11 at the location of the zones of potential contact between the conductive tracks 3 and 5, those studs 11 having dimensions in the plane of the upper layer 2 that are less than the width of a track 3 and less than the dimensions of the perforations 10′ of the intermediate layer 10.

In this manner, when the sensor 1 is pressed, the electrical contact between the conductive tracks 3 and 5, respectively of the upper layer 2 and lower layer 4, can only be established within the perforations 10′ of the intermediate layer 10 and over an area delimited by the area of the conductive studs 11. The contact area is thereby reduced all the more, and the electrical contact resistance increased for the same reason.

According to a fourth variant embodiment not shown, the electro-mechanical means directly comprise a proportion of the spacing means 8 arranged to limit the electrical contact area when there is a contact between at least one conductive track 3 of the upper layer 2 and at least one conductive track 5 of the lower layer 4.

More particularly, these spacing means 8 take up a large area, except at the location of the points 9 of potential contact between a conductive track 3 of the upper layer 2 and a conductive track 5 of the lower layer 4.

Thus, in this embodiment, the electro-mechanical means are constituted by the spacing means 8, already present in the touch sensor 1, but judiciously arranged. Consequently, it is no longer necessary to use additional electro-mechanical means to obtain an equivalent result.

The embodiments described above may be combined depending on the requirements it is desired for the sensor to meet.

If the above multi-contact sensor is intended to be positioned above a screen enabling different objects to be displayed, the different aforementioned layers are preferably transparent.

ITO has in particular the advantage of being a material that is conductive and transparent.

In use, a user presses on the upper layer of PET 2, and possibly with several fingers at the same time, the effect of which is that, in the embodiments described earlier, the upper layer 2 of ITO is in contact with the lower layer 4 of ITO, either directly within the perforations 10′ of an intermediate layer 10, or via conductive studs 11, or both.

Preferably, sequential scanning of the matrix formed by the rows and the columns of ITO may be carried out. This scanning is for example as described in the patent document EP 1 719 047.

Lastly, FIG. 14 represents a display device 20 according to the invention. In addition to a two-dimensional matrix multi-contact touch sensor 1, this display device comprises a display screen 22, a capture interface 23, a main processor 24 and a graphics processor 25.

The first fundamental element of this touch device is the multi-contact touch sensor 1, necessary for the acquisition—the multi-contact manipulation—using a capture interface 23. This capture interface 23 contains the circuits for acquisition and analysis. The touch sensor 1 is of matrix type. The sensor may possibly be divided into several parts in order to accelerate sensing, each part being scanned simultaneously.

The data from the capture interface 23 are conveyed, after filtering, to the main processor 24. This executes the local program enabling the data from the pad to be associated with graphical objects which are displayed on the screen 22 for example in order to be manipulated. The main processor 24 also conveys the data to be displayed on the display screen 22 to the graphical interface 25. This graphical interface may furthermore be controlled by a graphics processor.

The touch sensor is controlled in the following manner: at the time of a first scanning phase, the conductive tracks of one of the networks are successively supplied with power and the response on each of the conductive tracks of the other network is detected. According to these responses the contact zones are determined which correspond to the nodes whose state has been modified relative to the resting state. Determination is made of one or more sets of adjacent nodes whose state has been modified. A set of such adjacent nodes defines a contact zone. Position information, termed a cursor here, is computed from that set of nodes. In the case of several sets of nodes separated by inactive zones, several independent cursors will be determined during the same scanning phase.

This information is refreshed periodically during new scanning phases. The cursors are created, tracked or destroyed on the basis of the information obtained during successive scans. By way of example the cursor may be computed by a barycenter function of the contact zone. The general principle is to create as many cursors as there are zones detected on the touch sensor and to track them over time. When the user removes his fingers from the sensor, the associated cursors are destroyed. In this way, it is possible to sense the position and change for several fingers on the touch sensor simultaneously.

The matrix sensor 1 is a resistance type sensor here. It is composed of two transparent zones on which are arranged rows or columns corresponding to conductive tracks. These tracks are constituted by conductive wires. These two layers of conductive tracks thus form a matrix network of conductive wires.

When it is wished to know whether a row has been placed in contact with a column, determining a contact point on the sensor 1, the electrical characteristics—voltage, current or resistance—are measured at the terminals of each node of the matrix. The device makes it possible to acquire the data on the whole of sensor 1 with a sampling frequency of the order of 100 Hz, by employing the sensor 1 and the control circuit which is integrated into the main processor 24.

The main processor 24 executes the program enabling the data from the sensor to be associated with graphical objects which are displayed on the display screen 22 in order to be manipulated.

The second element enabling the display device to be produced is the display screen 22. This screen comprises a network of display pixels. These pixels are provided with three zones which are respectively red, green and blue, in order to produce a multicolor display. A backlighting device furthermore enables the screen to be illuminated from underneath, by passing through the sensor and its network of conductive tracks, in order to enable display.

The embodiments described above for the present invention are given by way of example and are in no way limiting. It is to be understood that the person skilled in the art is capable of producing different variants of the invention without however departing from the scope of the invention.

In particular, the person skilled in the art could add at least one resistive intermediate layer positioned between the spacers 8 and at least one layer out of the conductive upper layer 2 and the conductive lower layer 4. This intermediate layer may have a linear resistance greater than those of the upper layer 2 and lower layer 4, for example one hundred times greater. It may also have an impedance very much greater than the impedance of the conductive material (ITO) of the upper layer 2 and lower layer 4. A suitable value of vertical resistance for that intermediate layer may be comprised between 50 and 200 kiloOhms. For this it may be formed of semiconductor, for example from silicone. Its thickness may be of the order of 300 micrometers and its resistivity of the order of 640 Ohm.m.

1-13. (canceled)

14. A multi-contact touch sensor comprising:
an upper layer including first conductive tracks organized in rows;
a lower layer including second conductive tracks organized in columns;
spacing means positioned between the upper and lower layers so as to insulate the upper and lower layers; and
electro-mechanical means arranged between the upper and lower layers configured to reduce a contact area when a contact takes place between at least one conductive track of the upper layer and at least one conductive track of the lower layer.

15. A multi-contact touch sensor according to claim 14, in which the spacing means is disposed on the lower layer and the electro-mechanical means comprises intermediate dielectric layers disposed between the lower layer and the spacing means.

16. A multi-contact touch sensor according to claim 15, in which the intermediate dielectric layers take a form of a dielectric layer perforated at least at one point of potential contact between the at least one conductive track of the upper layer and the at least one conductive track of the lower layer.

17. A multi-contact touch sensor according to claim 16, in which the dielectric layer is perforated at all potential contacts between the conductive track of the upper layer and the conductive track of the lower layer.

18. A multi-contact touch sensor according to claim 16, in which the dielectric layer comprises plural perforations at a single point of potential contact between the conductive track of the upper layer and the conductive track of the lower layer.

19. A multi-contact touch sensor according to claim 14, in which the spacing means is disposed on the lower layer and the electro-mechanical means comprises conductive studs disposed on one of the upper and lower layers, at least at one point of potential contact between the at least one conductive track of the upper layer and the at least one conductive track of the lower layer.

20. A multi-contact touch sensor according to claim 19, in which the conductive studs are disposed at all potential contacts between the conductive track of the upper layer and the conductive track of the lower layer.

21. A multi-contact touch sensor according to claim 14, in which the spacing means is disposed on the lower layer and the electro-mechanical means comprises at least a proportion of the spacing means arranged to limit an electrical contact area when there is a contact between the at least one conductive track of the upper layer and the at least one conductive track of the lower layer.

22. A multi-contact touch sensor according to claim 21, in which arrangement of the spacing means makes it take up a large area, except at a location of points of potential contact between the conductive track of the upper layer and the conductive track of the lower layer.

23. A multi-contact touch sensor according to claim 14, in which the upper and lower layers are transparent.

24. A multi-contact touch sensor according to claim 14, in which the conductive tracks of the upper layer and the conductive tracks of the lower layer form a matrix of cells.

25. A multi-contact touch sensor according to claim 14, in which the upper layer is situated below a flexible layer.

26. A multi-contact touch sensor according to claim 14, in which the lower layer is situated above a rigid layer.
